(19) United States
(12) Patent Application Publication
(10) Pub. No.: US 2011/0291890 A1
(43) Pub. Date: Dec. 1, 2011

(54) METHOD FOR ANGULARLY REFINING THE ANTENNA BEAM OF A RADAR

(75) Inventors: Nicolas Bon, Brest (FR); Luc Bosser, Rambouillet (FR); Clémentine Costes, Plouzane (FR)

(73) Assignee: THALES, NEUILLY SUR SEINE (FR)

(21) Appl. No.: 12/997,599

(22) PCT Filed: Jun. 15, 2009
(86) PCT No.: PCT/EP09/57378

§ 371 Date: Jun. 8, 2011

(30) Foreign Application Priority Data
Jun. 13, 2008 (FR) 08 03318

(51) Int. Cl. H01Q 3/00

(52) U.S. Cl. 342/372

(57) ABSTRACT

The present invention relates to a method for angularly refining the antenna beam of a radar. The antenna performs M pointings along an axis, a signal being received by the antenna for each of said pointings, each of said signals being, on account of the shape of the antenna pattern, formed by the sum of signals reflected by several contributors distributed over the space scanned by the antenna beam, the method determining an estimation of the real-reflectivity vector w of N contributors by performing an inverse filtering on the vector s of the M signals received signals, said inverse filtering being established as a function of the known shape of the antenna pattern. The invention applies notably to airborne radars, and more particularly to meteorological radars.

The present invention relates to a method for angularly refining the antenna beam of a radar. The invention applies notably to airborne radars, and more particularly to meteorological radars.

In order to establish a three-dimensional representation of the space situated in front of a radar, which is for example an airborne meteorological radar, the antenna beam of the radar performs scans in elevation and in azimuth. For a given pointing, the signal received by the antenna is then equal to the sum of all the contributions situated in front of the radar, which contributions are weighted by the corresponding gain of the antenna pattern. Thus, a notable consequence of the beam aperture is the smoothing of the signals received on the elevation axis and on the azimuth axis. Hence, the resolution of the representation obtained is related to the aperture of the antenna lobe. In the case of airborne meteorological radars, which must enable an aircraft pilot to avoid dangerous convective zones, this smoothing phenomenon may be particularly troublesome in the precise determination of the position and of the extent of said convective zones.

An aim of the invention is to propose a method making it possible to refine the angular resolution of the radar data collected so as to correct the smoothing of the signals received, which smoothing is due to the shape of the antenna pattern. For this purpose, the subject of the invention is a method for angularly refining the antenna beam of a radar, the antenna performing M pointings along an axis, a signal sₘ being received by the antenna for each of said pointings, each of said signals sₘ being, on account of the shape of the antenna pattern, formed by the sum of signals reflected by several contributors distributed over the space scanned by the antenna beam, the method being characterized in that it determines an estimation wₒₚₜ of the real-reflectivity vector w of N contributors by performing an inverse filtering on the vector s of the M signals received sₘ, said inverse filtering being established as a function of the known shape of the antenna pattern.

Indeed, the representation of reality by the radar being affected by the shape of the antenna pattern, which plays the role of a filter through which the angular domain is observed, the method according to the invention performs an inverse filtering of the radar data so as to at least partially cancel the effect of this filter.

To obtain a good estimation wₒₚₜ, the number N of contributors over which the real reflectivity w is estimated is, preferably, less than the number M of pointings performed by the antenna.

According to one implementation of the method according to the invention, the estimated vector wₒₚₜ of the real reflectivity w of the N contributors is determined by minimizing the mean quadratic error between the vector s of the signals received and the product of the real-reflectivity vector w by the gain G of the antenna.

According to one implementation of the method according to the invention, the estimated vector wₒₚₜ of the real reflectivity w of the N contributors is determined by minimizing the mean quadratic error between a unit vector u and the product of the real-reflectivity vector w by the gain G of the antenna normalized by the vector s of the signals received. This normalization step makes it possible to improve the precision of estimation, since the dynamic swing in reflectivity obtained is sometimes very significant and affects the precision of estimation when no normalization step has been performed previously on the signals received.

According to one implementation of the method according to the invention, the optimal estimation wₒₚₜ of the real reflectivity w is determined by minimizing the quadratic error increased by a regularization term λ·F(w), said term being positive real-valued, λ being a regularization coefficient. This regularization term makes it possible to obtain better conditioning of the matrix to be inverted.

According to one implementation of the method according to the invention, the regularization term is proportional to the energy of the vector w of real reflectivity, i.e. λ·F(w)=λ·w^{T}·w.

According to one implementation of the method according to the invention, a step of determining the regularization coefficient λ is executed, the regularization term λ·F(w) being, in the course of this step, represented by a curve (201) on a logarithmic scale, for several values of regularization coefficients λ, as a function of the quadratic error to be minimized also on a logarithmic scale, the curve forming substantially an L, the optimal value of λ corresponding to the angle of the L.

According to one implementation of the method according to the invention, the radar is an airborne meteorological radar, the radar possibly being used for the detection of convective zones.

The subject of the invention is also a method for angularly refining the antenna beam of a radar iterating, firstly, the above-described method k times, the N contributors being shifted, at each iteration, on the radar scan axis, by a fraction of the spacing between two successive contributors, and secondly, the estimation values obtained for the k×N contributors being assembled into a single estimation vector wₒₚₜ complying with the order of position in space of the contributors, said vector wₒₚₜ comprising k×N estimated reflectivity values.

The subject of the invention is also a two-dimensional method for angularly refining the antenna beam of a radar scanning space in elevation and in azimuth, the method described above being executed, on the one hand, for the signals received along the azimuth axis, and on the other hand, for the signals received along the elevation axis. The method according to the invention can moreover be extended to a third dimension, it also being possible to apply an inverse filtering on the distance axis.

Other characteristics will become apparent on reading the following detailed description given by way of nonlimiting example and offered in relation to appended drawings which represent:

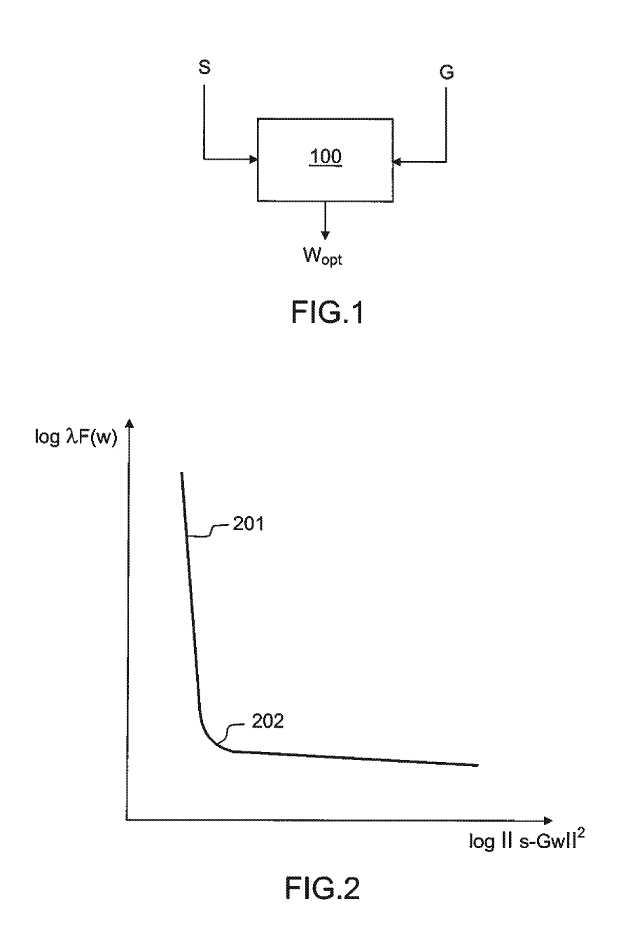

FIG. 1, a schematic illustrating the method of angular refinement according to the invention;

FIG. 2, a graph illustrating the L-curve technique for determining the regularization coefficient λ;

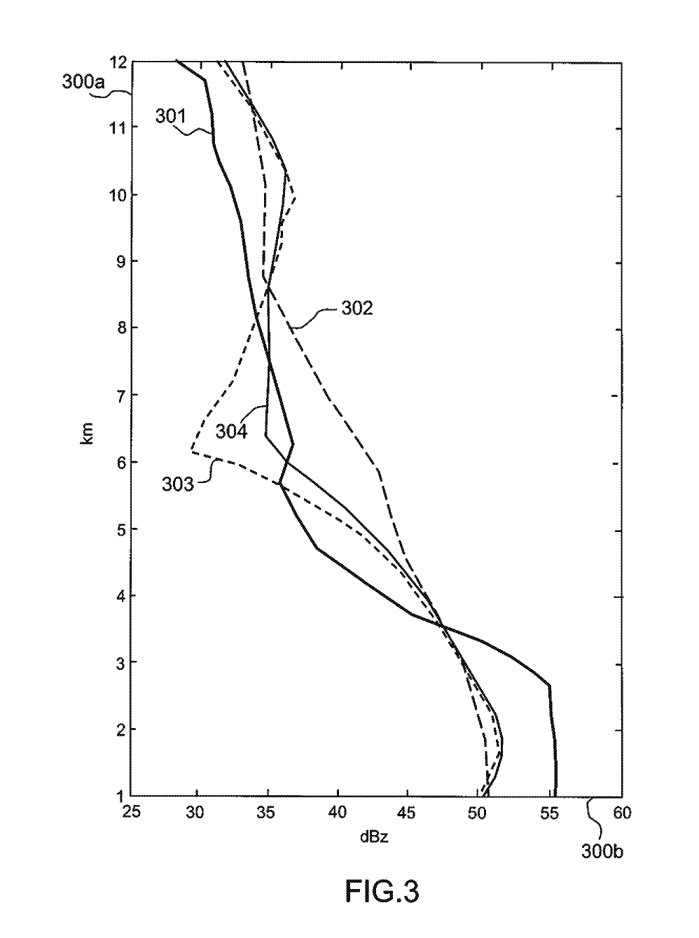

FIG. 3, a graph showing reflectivity curves obtained with and without the method according to the invention.

For the sake of clarity, the method presented subsequently deals only with the refinement of the resolution of the beam along the elevation axis. Nonetheless, the method can equally well be applied to improve the azimuthal resolution or indeed the resolution on both axes at one and the same time, on condition that sufficient pointings are performed.

In the example presented, for a given azimuth and a given distance, the antenna of the radar scans space in elevation, performing M pointings to obtain a vertical profile of reflectivity. For a pointing m out of the M pointings in elevation, the signal received sₘ is then expressed as the filtering of the response of N elementary reflecting contributors by the antenna pattern, as follows:

$${S}_{m} = {\sum }_{n = 1}^{N} {g}_{m , n} \cdot {w}_{n} + {b}_{m}$$

where m denotes the index of the pointing from among the M pointings carried out in elevation, n the index of an elementary contributor of the space observed from among N contributors whose real response wₙ one wishes to estimate, g_{m,n} the antenna gain of the pointing m at the position of the contributor n, and bₘ thermal noise.

The M signals received sₘ can then be assembled into a vector s as follows:

$$\begin{matrix}s = G \cdot w + b ⇔ [ \begin{matrix}{s}_{1} \\ ⋮ \\ {s}_{m} \\ ⋮ \\ {s}_{M}\end{matrix} ] \\ = [ \begin{matrix}{g}_{1 , 1} & … & {g}_{1 , n} & … & {g}_{1 , N} \\ ⋮ & … & ⋮ & … & ⋮ \\ {g}_{m , 1} & … & {g}_{m , n} & … & {g}_{m , N} \\ ⋮ & … & ⋮ & … & ⋮ \\ {g}_{M , 1} & … & {g}_{M , n} & … & {g}_{M , N}\end{matrix} ] \cdot [ \begin{matrix}{w}_{1} \\ ⋮ \\ ⋮ \\ {w}_{n} \\ ⋮ \\ ⋮ \\ {w}_{N}\end{matrix} ] + [ \begin{matrix}{b}_{1} \\ ⋮ \\ {b}_{m} \\ ⋮ \\ {b}_{M}\end{matrix} ]\end{matrix}$$

Hence, to determine the vector w of the responses wₙ of real reflectivity, it is possible, for example, to choose the least squares criterion and therefore to minimize the mean quadratic deviation between s and G·w. The optimal vector wₒₚₜ is then given by the following relation:

$${w}_{opt} = {min}_{w} {‖ s - Gw ‖}^{2}$$

thus leading to:

wₒₚₜ=(G^{T}G)⁻¹G^{T}_{S} [E1]

FIG. 1 illustrates, through a schematic, a method of angular refinement according to the invention. The method of FIG. 1 receives as input the vector s of the signals received sₘ and the antenna gain matrix G. It then executes, by way of a computational processor, a step 100 of determining the vector wₒₚₜ, based on the relation [E1].

In the example, a set of N regularly spaced contributors is considered. Moreover, the conditioning of the matrix G^{T}G depends notably on the angular spacing between the elementary contributors and on the power of the perceived noise. In order to guarantee good conditioning of this matrix, the number of contributors is chosen so that the spacing between said contributors is not too small. By way of example, for mean noise levels, the spacing between contributors may not be reduced below a third of the width of the antenna beam.

Sometimes, notably when studying meteorological observation signals, the dynamic swing of the reflectivity measurements obtained is very wide. It can, for example, attain 70 dBZ. Now, to guarantee satisfactory precision of the sought-after vector wₒₚₜ, it may be preferable to minimize a relative error rather than an absolute error. This is why, in another implementation of the method according to the invention, the vector s of the signals sₘ received is normalized:

$$\frac{{s}_{m}}{{s}_{m}} = {\sum }_{n = 1}^{N} \frac{{g}_{m , n}}{{s}_{m}} \cdot {w}_{n} + \frac{{b}_{m}}{{s}_{m}}$$

$$whence \text{:}$$

$${w}_{opt} = {min}_{w} {‖ u - {G}_{w} w ‖}^{2}$$

$$with u = [ \begin{matrix}1 \\ ⋮ \\ 1\end{matrix} ] and$$

$${G}_{s} = [ \begin{matrix}\frac{{g}_{1 , 1}}{{s}_{1}} & … & \frac{{g}_{1 , n}}{{s}_{1}} & … & \frac{{g}_{1 , N}}{{s}_{1}} \\ ⋮ & … & ⋮ & … & ⋮ \\ \frac{{g}_{m , 1}}{{s}_{m}} & … & \frac{{g}_{m , n}}{{s}_{m}} & … & \frac{{g}_{m , N}}{{s}_{m}} \\ ⋮ & … & ⋮ & … & ⋮ \\ \frac{{g}_{M , 1}}{{s}_{M}} & ⋯ & \frac{{g}_{M , n}}{{s}_{M}} & … & \frac{{g}_{M , N}}{{s}_{M}}\end{matrix} ]$$

thus giving the following reflectivity vector:

wₒₚₜ=(G^{T}_{S}G_{S})⁻¹G^{T}_{S}u

Besides, the type of processor used to perform the computations, the division of the matrix by overly small values sᵢₙ can affect the conditioning of the matrix G_{S}^{T}G_{S} because of numerical errors, in particular if the numerical precision of said processor is insufficient. Hence, a test of the conditioning of the matrix may be performed beforehand so as to verify the invertibility of the matrix G_{S}^{T}G_{S}. For example, if the ratio of its maximum eigenvalue to its minimum eigenvalue exceeds a threshold, then the matrix G^{T}_{S}G_{S} is considered to be too unstable to perform the computation of wₒₚₜ.

When seeking to further refine the resolution of the measurements, increasing the number of contributors, stated otherwise, reducing the spacing between each of the contributors, may turn out to be unsuitable since, as explained above, too small a spacing can degrade the conditioning of the matrix. Hence, to circumvent this difficulty, the method according to the invention may be repeated while preserving the same number N of contributors but shifting their position by an interval equal to a fraction of the spacing between two contributors. By iterating the method k times, k estimation vectors wₒₚₜ are obtained, each of these vectors comprising reflectivity values corresponding to contributors shifted in position. By way of example, for k equal to 3, we obtain:

$${w}_{opt 1} = [ \begin{matrix}{w}_{11} \\ ⋮ \\ {w}_{1 i} \\ ⋮ \\ {w}_{1 N}\end{matrix} ] ; {w}_{opt 2} = [ \begin{matrix}{w}_{21} \\ ⋮ \\ {w}_{2 i} \\ ⋮ \\ {w}_{2 N}\end{matrix} ] ; {w}_{opt 3} = [ \begin{matrix}{w}_{31} \\ ⋮ \\ {w}_{3 i} \\ ⋮ \\ {w}_{3 N}\end{matrix} ]$$

The vectors wₒₚₜ₁, wₒₚₜ₂, wₒₚₜ₃ are thereafter combined, so as to obtain a single estimated vector wₒₚₜ comprising three times as many contributors:

$${w}_{opt } = [ \begin{matrix}{w}_{11} \\ {w}_{21} \\ {w}_{31} \\ ⋮ \\ {w}_{1 i} \\ {w}_{2 i} \\ {w}_{3 i} \\ ⋮ \\ {w}_{1 N} \\ {w}_{2 N} \\ {w}_{3 N}\end{matrix} ]$$

According to another implementation of the method according to the invention, a regularization term λ·F(w) may be added to the minimization criterion with a view to improving the conditioning of the matrix to be inverted and to introducing a constraint on the vector wₒₚₜ sought. The function F is positive real-valued and λ is the regularization coefficient. The regularization term may be added with or without normalization by the vector s of the measured signals. In the detailed example which follows, the regularization term is added without prior normalization.

Taking account of this regularization term, the optimal vector wₒₚₜ is expressed as follows:

$${w}_{opt} = {min}_{w} ( {‖ s - Gw ‖}^{2} + λ \cdot F ( w ) )$$

The regularization term λ·F(w) makes it possible to add a priori knowledge about the solution sought. Several types of functions may be chosen to fulfill the role of the function F, which can for example be expressed as the energy of the vector w, that is to say w^{T}·w, as the energy of the differences or else as other, more complex, non-linear functions.

The solution wₒₚₜ taking account of the regularization term may then be written:

wₒₚₜ=(G^{T}G+λD)⁻¹G^{T}s

where D is a matrix equal to the identity when F is equal to the energy of the vector w; in the case of a function F equal to the energy of the differences, D takes the following form:

$$D = [ \begin{matrix}1 & - 1 & 0 & … & 0 \\ 0 & 1 & - 1 & ⋱ & ⋮ \\ ⋮ & ⋱ & … & ⋱ & 0 \\ 0 & … & 0 & 1 & - 1\end{matrix} ]$$

Furthermore, the apportionment of the weight between the measurements and the a priori knowledge may be adjusted by modifying the regularization coefficient λ, a high coefficient λ allotting more importance to the a priori knowledge than to the measurements.

According to one implementation of the method according to the invention, the regularization coefficient λ may be chosen by using the L-curve procedure, illustrated in FIG. 2.

FIG. 2 presents a graph illustrating the L-curve technique for determining the regularization coefficient λ.

According to this procedure, the regularization term λ·F(w) is represented as a function of the criterion to be minimized, in the example the least squares criterion ∥s−Gw|², by varying the regularization coefficient λ, the curve 201 being represented on a logarithmic scale in abscissa and in ordinate. Generally, this curve takes substantially the shape of an L and the value A corresponding to the angle 202 of the L results in a good compromise between faithfulness to the measurements performed by the radar and faithfulness to the a priori knowledge.

In order to illustrate the results obtained by virtue of the method according to the invention, FIG. 3 presents a graph showing reflectivity curves obtained with and without the execution of a method according to the invention.

The graph comprises a first axis 300a of distances in elevation and a second axis 300b of reflectivity level. A first curve 301 shows the real reflectivity of the environment observed by the radar. A second curve 302 shows the measurements performed by the radar. A third curve 303 shows reflectivity measurements with an inverse filtering by least squares by a method according to the invention. Finally, a fourth curve 304 shows reflectivity measurements with an inverse filtering by least squares integrating a regularization term, by a method according to the invention.

It may be noted that the third 303 and fourth curves 304, obtained by virtue of the method according to the invention, have a shape closer to the first curve 301 representing reality than the second curve 302 depicting the raw measurements, without inverse filtering.

Moreover, without departing from the scope of the invention, procedures other than the least squares procedure may be employed to perform the inverse filtering of the data collected by the radar. Thus, signal processing procedures such as the generalized inverse, spectral division, Wiener filtering or the Bayesian approach can also make it possible to estimate the real-reflectivity vector w.

1. A method for angularly refining the antenna beam of a radar, the antenna performing M pointings along an axis, a signal sₘ being received by the antenna for each of said pointings, each of said signals sₘ being, on account of the shape of the antenna pattern, formed by the sum of signals reflected by several contributors distributed over the space scanned by the antenna beam, said method comprising determining an estimation wₒₚₜ of the real-reflectivity vector w of N contributors by performing an inverse filtering on the vector s of the M signals received sₘ, said inverse filtering being established as a function of the known shape of the antenna pattern.

2. The method as claimed in claim 1, wherein the number N of contributors over which the real reflectivity w is estimated is less than the number M of pointings performed by the antenna.

3. The method as claimed in claim 1, wherein the estimated vector wₒₚₜ of the real reflectivity w of the N contributors is determined by minimizing the mean quadratic error between the vector of the signals received and the product of the real-reflectivity vector w by the gain G of the antenna.

4. The method as claimed in claim 1, wherein the estimated vector wₒₚₜ of the real reflectivity w of the N contributors is determined by minimizing the mean quadratic error between a unit vector u and the product of the real-reflectivity vector w by the gain G of the antenna normalized by the vector s of the signals received.

5. The method as claimed in claim 3, wherein the optimal estimation wₒₚₜ of the real reflectivity w is determined by minimizing the quadratic error increased by a regularization term λ·F(w), said term being positive real-valued, λ being a regularization coefficient.

6. The method as claimed in claim 5, wherein the regularization term is proportional to the energy of the vector w of real reflectivity λ·F(w)=λ·w^{T}·w.

7. The method as claimed in claim 5, further comprising a step of determining the regularization coefficient λ, the regularization term λ·F being represented by a curve on a logarithmic scale, for several values of regularization coefficients λ, as a function of the quadratic error to be minimized also on a logarithmic scale, the curve forming substantially an L, the optimal value of λ corresponding to the angle of the L.

8. The method as claimed in claim 1, wherein the radar is an airborne meteorological radar.

9. A method for angularly refining the antenna beam of a radar, said method comprising iterating k times the method according to claim 1, the N contributors being shifted, at each iteration, on the radar scan axis, by a fraction of the spacing between two successive contributors, and secondly, the estimation values obtained for the k×N contributors are assembled into a single estimation vector wₒₚₜ complying with the order of position in space of the contributors, said vector wₒₚₜ comprising k×N estimated reflectivity values.

10. A two-dimensional method for angularly refining the antenna beam of a radar scanning space in elevation and in azimuth, the step of the method as claimed in claim 1 being executed, on the one hand, for the signals received along the azimuth axis, and on the other hand, for the signals received along the elevation axis.
